(19) United States
(12) Patent Application Publication
(10) Pub. No.: US 2017/0228722 A1
(43) Pub. Date: Aug. 10, 2017

(54) REAL-TIME VALUATION DISPLAY FOR TRANSACTION CARDS

(71) Applicant: AT&T Intellectual Property I, L.P., Atlanta, GA (US)

(72) Inventors: Isabella G. Szutkowski, Metuchen, NJ (US); Ellen B. Feinberg, Morganville, NJ (US); David Lewis, Freehold, NJ (US)

(21) Appl. No.: 15/017,074

(22) Filed: Feb. 5, 2016

(51) Int. Cl. G06Q 20/34; G06K 19/06

(52) U.S. Cl. CPC G06Q 20/3433; G06Q 20/3563; G06K 19/06028; G06K 19/06037

(57) ABSTRACT

A method includes determining a value amount associated with a transaction card having an optical code. The method also includes, based on a transaction involving the transaction card, updating the value amount. The method also includes determining that the optical code has been read. Responsive to the optical code being read, the method includes causing a display associated with the transaction card to render the value amount.

### TECHNICAL FIELD

The technical field generally relates to transaction cards and, more specifically, for methods and systems for providing a current value of a transaction card in response to a request.

### BACKGROUND

Transaction cards, including any cards that carry or can be loaded with value are popular. Transaction cards may include phone cards, gift cards, prepaid debit or credit cards, or the like. Transaction cards may be loaded with minutes, a cash value (e.g., including ones that may be generally accepted by multiple merchants or those accepted by limited merchants), points, or the like. The value of these cards may change based on transactions, such as spending minutes or cash, earning points, or reloading the cards. One of the problems with these cards is that a current value of the card is not easily obtained. Some systems allow for a cardholder to call a number, input a transaction card ID number and PIN to determine a current value. Other systems print the value at the bottom of a receipt.

These solution require a user to make a purchase transaction or enter a long ID number. There is a need for an easier solution process for a user to determine a current value of a transaction card.

### SUMMARY

The following presents a simplified summary that describes some aspects or embodiments of the subject disclosure. This summary is not an extensive overview of the disclosure. Indeed, additional or alternative embodiments of the subject disclosure may be available beyond those described in the summary.

In an aspect, this disclosure is directed to a method. The method may comprise determining a value amount associated with a transaction card, the transaction card having an optical code and, based on a transaction involving the transaction card, updating the value amount. The method may also include determining that the optical code has been read. Responsive to the optical code being read, the method may include causing a display associated with the transaction card to render the value amount.

In another aspect, this disclosure is directed to a device. The device may include a processor and memory storing instructions that cause the processor to effectuate operations. the operations may include determining a value amount associated with a transaction card. The transaction card may have an optical code. The operations may include, based on a transaction involving the transaction card, updating the value amount. The operations may also include determining that the optical code has been read and, responsive to the optical code being read, causing a display associated with the transaction card to render the value amount.

According to another aspect, this disclosure is directed to a method. The method may include determining a value amount associated with a transaction card and, based on a transaction involving the transaction card, updating the value amount. The method may also include initiating a timer associated with the transaction card. The method may include, based on an expiration of the timer, decrementing the value amount by an expiration amount. The method may also include causing a display associated with the transaction card to render the value amount.

### BRIEF DESCRIPTION OF THE DRAWINGS

Reference is made here to the accompanying drawings, which are not necessarily drawn to scale.

FIG. 1 illustrates an exemplary transaction card.

FIG. 2 illustrates an exemplary system that can be used for providing an indication of a value amount associated with a transaction card.

FIG. 3 is a flowchart of an exemplary method that can be used for providing an indication of a value amount associated with a transaction card.

FIG. 4 is a flowchart of an exemplary method that can be used for providing an indication of a value amount associated with a transaction card.

FIG. 5 illustrates an exemplary device that can be used for providing an indication of a value amount associated with a transaction card.

### DETAILED DESCRIPTION OF ILLUSTRATIVE EMBODIMENTS

Aspects of the instant disclosure are described more fully herein with reference to the accompanying drawings, in which example embodiments are shown. In the following description, for purposes of explanation, numerous specific details are set forth in order to provide an understanding of the various embodiments. However, the instant disclosure may be embodied in many different forms and should not be construed as limited to the example embodiments set forth herein. Like numbers refer to like elements throughout.

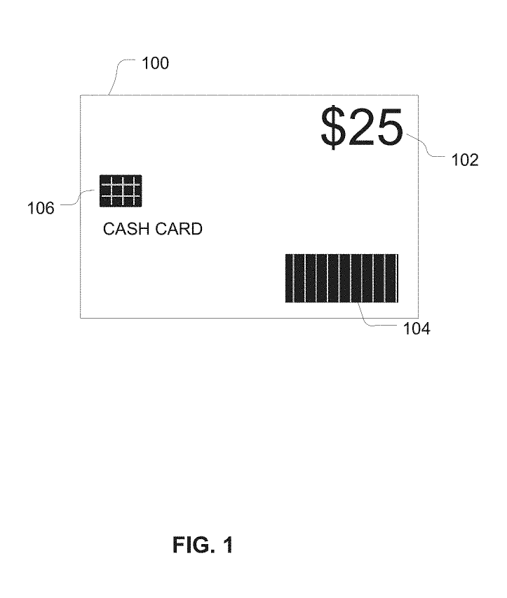

FIG. 1 illustrates an exemplary transaction card 100. Transaction card 100 may be any type of card that can be used to spend or earn any type of currency. For example, transaction card 100 may be loaded with cash that can be spent at multiple merchants (e.g., a prepaid credit card or prepaid debit card), cash that can be spent at specific merchants (e.g., a gift card for XYZ store), value that can be exchanged for goods or services (e.g., phone cards), points that can be accumulated (e.g., frequent flier cards or get-your-fifth-coffee-free cards), a transit card (e.g., bus/subway card that stores value as a monetary amount or number of rides) or any other type of value-exchange card. Transaction card 100 may have an initial value, or transaction card 100 may be loaded with a value. For example, FIG. 1 shows transaction card 100 having an initial value 102 of twenty-five dollars. As transaction card 100 may be used, the initial value may change, such as when all or a portion of initial value 102 is spent or additional value is added to transaction card 100.

Transaction card 100 may have an optical code 104 that may be readable by a scanner, camera, or other optical input. For example, optical code 104 may comprise a one-dimensional barcode, such as a UPC barcode. A one-dimensional barcode may comprise a series of parallel lines and spaces of varying width. Optical code 104 may comprise a two-dimensional barcode, such as a QR code, Qode, MaxiCode, ShotCode, or the like. A two-dimensional barcode (e.g., matrix code) may comprise symbols or geometric patterns such as rectangles, dots, hexagons, or the like. Optical code 104 may be monochromatic, or it may include color coding. While FIG. 1 illustrates optical code 104 as being integrated into transaction card 100, optical code 104 may be separate from transaction card 104. In an aspect, optical code 104 may be a sticker than can be affixed to transaction card 104 or any other surface.

Transaction card 100 may optionally comprise a smart card. That is, transaction card 100 may comprise an integrated circuit (IC) 106, which may be embedded in card 100. Optionally, IC 106 may comply with the EMV standards (e.g., ISO/IEC 7816 or ISO/IEC 14443). For example, IC 106 may comprise data related to transaction card 100, such as a PIN, cardholder information, card balance, or the like.

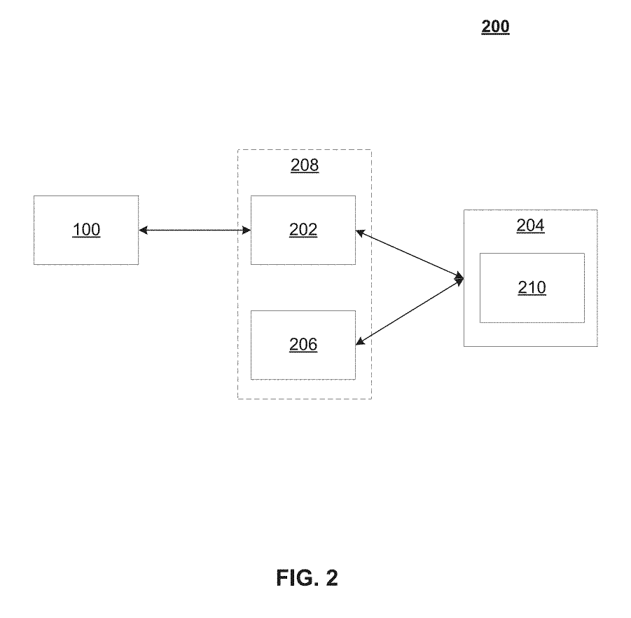

FIG. 2 is an exemplary system 200 that may be used for providing real-time valuation data associated with transaction card 100. System 200 may include an optical input 202 that may be used to read optical code 104 of transaction card 100. Optical input 202 may be a scanner, such as a laser scanner or LED scanner. In an aspect, optical input 202 may be a camera. Optical input 202 may be configured to communicate with a valuation system 204. Valuation system 204 may include a database or other data storage that keeps track of the value amount associated with transaction card 100. For example, valuation system 204 may comprise or communicate with the backend system used for authorizing transactions and transferring funds based on those transactions using transaction card 100. Optionally, this information may be stored in or accessed by IC 106. In response to a transmission from optical input 202, valuation system 204 may provide the value amount associated with transaction card 100. The value amount may be rendered on a display 206.

Display 206 may be associated with transaction card 100. For example, transaction card 100 may have display 206 integrated into a surface of transaction card 100 or may be a separate display, such as a cardholder having an LED display. Display 206 may be an LED screen that may be powered by a solar power source, such as a photovoltaic cell, of transaction card 100. As another example, display 206 may be part of a mobile device 208 that is registered or associated with transaction card. Optionally, optical input 202 and display 206 may be part of the same device. For example, mobile device 208 may include a camera (i.e., optical input 202) and a screen (i.e., display 206). While not shown, all or a portion of valuation system 204 may optionally be incorporated in mobile device 208.

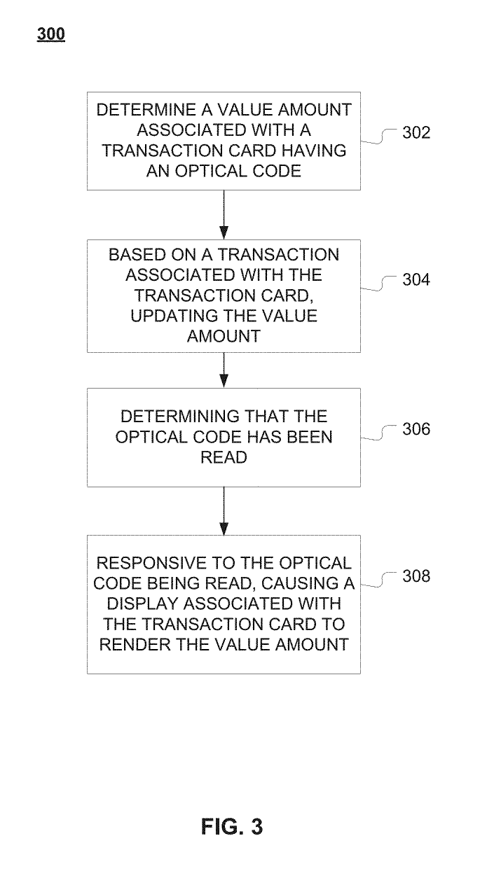

FIG. 3 is a flowchart of an exemplary method 300. Method 300 may be used for providing an indication of a value amount. For example, at step 302, method 300 may include determining a value amount associated with transaction card 100. This may be initial value 102 that is associated with the card. Optionally, the value amount may be a different amount.

A transaction associated with transaction card 100 may affect the value amount. For example, if transaction card 100 (or an account associated with transaction card 100) is used to purchase a good or service, the value amount may decrease. As another example, a transaction may include loading additional value onto transaction card 100. At step 304, method 300 may include updating the value amount based on the transaction.

A user may desire to know the current value amount associated with transaction card 100. In order to obtain this information, a user may scan optical code 104 or IC 106. At step 306, it may be determined that optical code 104 or IC 106 has been read. This may be based on receiving a transmission including data associated with transaction card 100, such as data represented by optical code 104 or IC 106. Step 306 may be based on at least mobile device 208 capturing an image of optical code 104.

In response to optical code 104 being read, at step 308, method 300 may include causing display 206 associated with transaction card 100 to render the value amount. For example, this may include sending a communication to mobile device 208. The communication may comprise the value amount. The communication may be an SMS or MMS message or an email directed to mobile device 208. Optionally, mobile device 208 may include a mobile application that displays the value amount in response to receiving a communication indicative of the value amount or the request for the value amount. For example, step 308 may include causing a push notification to appear on display 206 of mobile device 208.

Method 300 may include additional functionality. For example, the value of transaction card 100 may expire after a certain amount of time. For example, the value may decrease by 10% every month that no transaction involving transaction card 100 occurs, or the value may be decrease by $10.00 every twelve months. Referring again to FIG. 2, valuation system 204 may comprise a timer 210 that measures time from one or more transactions associated with transaction card 100. For example, timer 210 may reset after any transaction associated with transaction card 100. Or timer 210 may reset when transaction card 100 is purchased or loaded with value. When timer 210 expires, the value amount associated with transaction card 100 may be decremented. Timer 210 may optionally comprise IC 106.

A threshold may be associated with timer 210. When the threshold is reached, method 300 may include causing display 206 to render a value change warning. For example, the threshold may be 24 hours prior to the expiration of timer 210. In this example, 24 hours before timer 210 expires, display 206 may indicate that the value amount of transaction card 100 will decrease within 24 hours. In an aspect, the value change warning may indicate an action that may cause time to be added to timer 210. For example, value change warning may indicate that if transaction card 100 is used in a transaction (e.g., value is added to transaction card 100 or transaction card 100 is used to make a purchase), then timer 210 may be reset.

As another example, a minimum balance may be associated with transaction card 100. This minimum balance may be the minimum value amount that transaction card 100 can carry without incurring fees. For example, if transaction card 100 has a minimum balance of $5.00, transaction card 100 may incur a fee if the value dips below $5.00, or if it dips below $5.00 for a certain amount of time (e.g., 48 hours). In an aspect, a user may set a minimum desired balance that he/she desired to have on transaction card 100. Method 300 may include functionality to provide minimum balance alerts that warn a user that a current value of transaction card 100 is below or within a certain range of the minimum balance.

In an aspect, method 300 may include causing display 206 to render the value amount even without optical code 104 being read. For example, if valuation system 204 detects the occurrence of a transaction involving transaction card 100, valuation system 204 may cause display 206 to render the value amount. Display 206 may render the value amount after factoring in any change to the value amount based on the transaction.

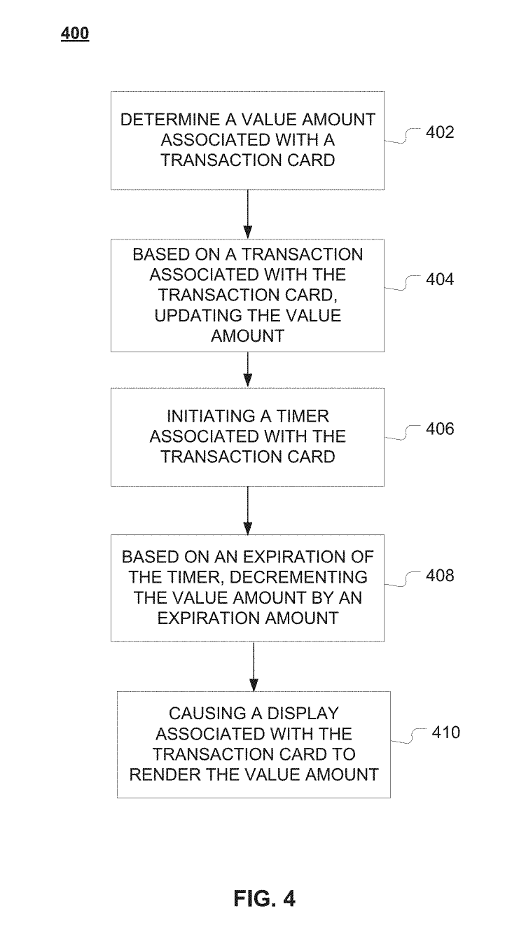

FIG. 4 is a flowchart of an exemplary method 400. Method 400 may be used for providing an indication of a value amount. For example, at step 402, method 400 may include determining a value amount associated with transaction card 100. This may be initial value 102 that is associated with the card. Optionally, the value amount may be a different amount.

A transaction associated with transaction card 100 may affect the value amount. For example, if transaction card 100 (or an account associated with transaction card 100) is used to purchase a good or service, the value amount may decrease. As another example, a transaction may include loading additional value onto transaction card 100. At step 404, method 300 may include updating the value amount based on the transaction.

At step 406, method 400 may include initiating timer 210 associated with transaction card 100. The initiation of timer 210 may coincide with the transaction involved in step 404. When timer 210 expires, at step 408, method 400 may include decrementing the value amount by an expiration amount. The expiration amount may be a predetermined value (e.g., $2.00) or a percentage of the value amount (e.g., 10% of the value amount).

At step 410, method 400 may include causing display 206 associated with transaction card 100 to render the value amount. For example, this may include sending a communication to mobile device 208. The communication may comprise the value amount. The communication may be an SMS or MMS message or an email directed to mobile device 208. Optionally, mobile device 208 may include a mobile application that displays the value amount in response to receiving a communication indicative of the value amount or the request for the value amount. For example, step 410 may include causing a push notification to appear on display 206 of mobile device 208.

As discussed above with respect to method 300, a threshold may be associated with timer 210. When the threshold is reached, method 400 may include causing display 206 to render a value change warning. In an aspect, the value change warning may indicate an action that may cause time to be added to timer 210. For example, value change warning may indicate that if transaction card 100 is used in a transaction (e.g., value is added to transaction card 100 or transaction card 100 is used to make a purchase), then timer 210 may be reset.

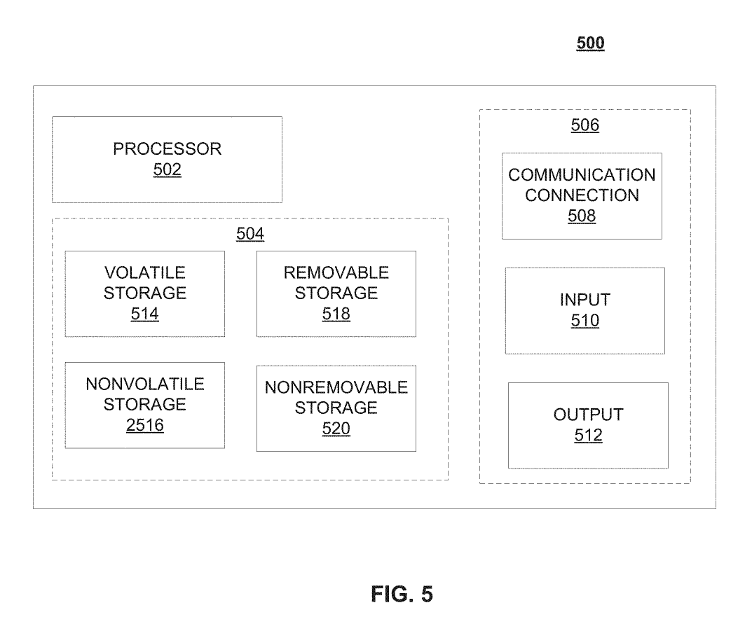

FIG. 5 illustrates a network device 500 that may be used to provide an indication of a value amount associated with transaction card 100. In an aspect, network device 500 may comprise one or more of optical input 202, valuation system 204, display 206, mobile device 308, or timer 210. Network device 500 may comprise a processor 502 and a memory 504 coupled to processor 502. Memory 504 may contain executable instructions that, when executed by processor 502, cause processor 502 to effectuate operations associated with mapping wireless signal strength. As evident from the description herein, network device 500 is not to be construed as software per se.

In addition to processor 502 and memory 504, network device 500 may include an input/output system 506. Processor 502, memory 504, and input/output system 506 may be coupled together (coupling not shown in FIG. 5) to allow communications therebetween. Each portion of network device 500 may comprise circuitry for performing functions associated with each respective portion. Thus, each portion may comprise hardware, or a combination of hardware and software. Accordingly, each portion of network device 500 is not to be construed as software per se. Input/output system 506 may be capable of receiving or providing information from or to a communications device or other network entities configured for telecommunications. For example input/output system 506 may include a wireless communications (e.g., 2.5G/3G/4G/GPS) card. Input/output system 506 may be capable of receiving or sending video information, audio information, control information, image information, data, or any combination thereof. Input/output system 506 may be capable of transferring information with network device 500. In various configurations, input/output system 506 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 506 may comprise a Wi-Fi finder, a two-way GPS chipset or equivalent, or the like, or a combination thereof.

Input/output system 506 of network device 500 also may contain communication connection 208 that allows network device 500 to communicate with other devices, network entities, or the like. Communication connection 508 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 506 also may include an input device 510 such as keyboard, mouse, pen, voice input device, or touch input device. Input/output system 506 may also include an output device 512, such as a display, speakers, or a printer.

Processor 502 may be capable of performing functions associated with telecommunications, such as functions for processing broadcast messages, as described herein. For example, processor 502 may be capable of, in conjunction with any other portion of network device 500, determining a type of broadcast message and acting according to the broadcast message type or content, as described herein.

Memory 504 of network device 500 may comprise a storage medium having a concrete, tangible, physical structure. As is known, a signal does not have a concrete, tangible, physical structure. Memory 504, as well as any computer-readable storage medium described herein, is not to be construed as a signal. Memory 504, as well as any computer-readable storage medium described herein, is not to be construed as a transient signal. Memory 504, as well as any computer-readable storage medium described herein, is not to be construed as a propagating signal. Memory 504, as well as any computer-readable storage medium described herein, is to be construed as an article of manufacture.

Memory 504 may store any information utilized in conjunction with telecommunications. Depending upon the exact configuration or type of processor, memory 504 may include a volatile storage 514 (such as some types of RAM), a nonvolatile storage 216 (such as ROM, flash memory), or a combination thereof. Memory 504 may include additional storage (e.g., a removable storage 518 or a nonremovable storage 520) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 500. Memory 504 may comprise executable instructions that, when executed by processor 502, cause processor 502 to effectuate operations to determine or display a value amount associated with transaction card 100.

While example embodiments of enhanced location based services have been described in connection with various computing devices/processors, the underlying concepts may be applied to any computing device, processor, or system capable of implementing enhanced location based services. The various techniques described herein can be implemented in connection with hardware or software or, where appropriate, with a combination of both. Thus, the methods and apparatuses of using and implementing enhanced location based services may be implemented, or certain aspects or portions thereof, can take the form of program code (i.e., instructions) embodied in tangible storage media having a tangible physical structure. Examples of tangible storage media include floppy diskettes, CD-ROMs, DVDs, hard drives, or any other tangible machine-readable storage medium (computer-readable storage medium). Thus, a computer-readable storage medium is not a transient signal per se. A computer-readable storage medium is not a propagating signal per se. When the program code is loaded into and executed by a machine, such as a computer, the machine becomes an apparatus for implementing enhanced location based services. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for using and implementing enhanced location based services also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for implementing enhanced location based services. When implemented on a general-purpose processor, the program code combines with the processor to provide a unique apparatus that operates to invoke the functionality of enhanced location based services.

While enhanced location based services have been described in connection with the various embodiments of the various figures, it is to be understood that other similar embodiments can be used or modifications and additions can be made to the described embodiments for implementing enhanced location based services without deviating therefrom. For example, one skilled in the art will recognize that enhanced location based services as described in the present application may apply to any environment, whether wired or wireless, and may be applied to any number of such devices connected via a communications network and interacting across the network. Therefore, enhanced location based services should not be limited to any single embodiment, but rather should be construed in breadth and scope in accordance with the appended claims.

What is claimed:

1. A method comprising:
determining a value associated with a transaction card having an optical code;
based on a transaction associated with the transaction card, updating the value;
determining that the optical code has been read; and
responsive to the optical code being read, causing a display associated with the transaction card to render the value.

2. The method of claim 1, wherein the optical code comprises a barcode.

3. The method of claim 1, wherein the optical code comprises a two-dimensional code.

4. The method of claim 1, wherein determining that the optical code has been read is based on at least a mobile device capturing an image of the optical code.

5. The method of claim 4, wherein the mobile device comprises the display associated with the transaction card.

6. The method of claim 1, further comprising:
initiating a timer associated with the transaction card;
based on the timer reaching a threshold, causing the display to render a value change warning; and
based on an expiration of the timer, decrementing the value amount by an expiration amount.

7. The method of claim 1, wherein causing the display to render the value amount comprises sending a communication to a mobile device associated with the transaction card, the communication comprising the value amount.

8. The method of claim 1, comprising:
detecting a change in the value amount; and
responsive to the change, causing the display to render the value amount.

9. A device comprising:
a processor; and
memory storing instructions that cause the processor to effectuate operations comprising:
determining a value amount associated with a transaction card, the transaction card having an optical code;
based on a transaction involving the transaction card, updating the value amount;
determining that the optical code has been read; and
responsive to the optical code being read, causing a display associated with the transaction card to render the value amount.

10. The device of claim 9, wherein the optical code comprises a machine-readable optical label.

11. The device of claim 9, wherein the optical code comprises a two-dimensional code.

12. The device of claim 9, further comprising
a camera,
wherein determining that the optical code has been read is based on at least the camera device capturing an image of the optical code.

13. The device of claim 9, wherein the device comprises the display.

14. The device of claim 9, the operations further comprising:
initiating a timer associated with the transaction card;
based on the timer reaching a threshold, causing the display to render a value change warning; and
based on an expiration of the timer, decrementing the value amount by an expiration amount.

15. The device of claim 9, wherein causing the display to render the value amount comprises sending a communication to a mobile device associated with the transaction card, the communication comprising the value amount.

16. The device of claim 9, the operations further comprising:
detecting a change in the value amount; and
responsive to the change, causing the display to render the value amount.

17. A method comprising:
determining a value amount associated with a transaction card;
based on a transaction involving the transaction card, updating the value amount;
initiating a timer associated with the transaction card;
based on an expiration of the timer, decrementing the value amount by an expiration amount; and
causing a display associated with the transaction card to render the value amount.

18. The method of claim 17, wherein the transaction card comprises the display.

19. The method of claim 18, wherein the display receives power from a solar power source.

20. The method of claim 17, further comprising, based on the time reaching a threshold, causing the display to render an alert indicative of an upcoming loss of funds.
